(19) United States
(12) Patent Application Publication
(10) Pub. No.: US 2020/0003307 A1
(43) Pub. Date: Jan. 2, 2020

(54) ANNULAR SEALING DEVICE

(71) Applicant: Mahle International GmbH, Stuttgart (DE)

(72) Inventors: Oliver Grill, Moetzingen (DE); Achim Herber, Vaihingen (DE)

(21) Appl. No.: 16/440,960

(22) Filed: Jun. 13, 2019

(30) Foreign Application Priority Data
Jun. 13, 2018 (DE) 102018209469.1

(51) Int. Cl. F16J 15/10

(52) U.S. Cl. CPC F16J 15/104; F16J 15/102

(57) ABSTRACT

An annular sealing device may include a support ring and a sealing ring of a sealing material. The support ring may have an axial face end, an inner lateral surface, and a plurality of passage openings. The sealing ring may have an L-shaped cross section, a radial sealing surface, and an axial sealing surface and may lie against the inner lateral surface and the axial face end. The plurality of passage openings may each have an undercut directed radially to an outside. The plurality of passage openings may define a negative form for a plurality of connecting webs. The sealing ring may be a plastic injection moulding and injection moulded onto the support ring such that the axial sealing surface, the radial sealing surface, and the plurality of connecting webs are a single piece and the plurality of undercuts are at least partly filled with the sealing material.

### CROSS-REFERENCE TO RELATED APPLICATIONS

This application claims priority to German Patent Application No. DE 10 2018 209 469.1, filed on Jun. 13, 2018, the contents of which are hereby incorporated by reference in its entirety.

### TECHNICAL FIELD

The present invention relates to an annular sealing device. The invention additionally relates to a cooling device having a coolant flowing in a cooling circuit and having such a sealing device.

### BACKGROUND

Modern sealing devices, such as for example sealing rings, are often made of material combinations in order to, on the one hand, be able to achieve as great as possible and long-lasting a sealing effect with a sealing material and on the other hand achieve high dimensional stability for the sealing material with a support material. However, in order to produce for example sealing devices of plastic with a sealing ring of rubber, elaborate pre-treatments are required in order to be able to permanently ensure the connection between the sealing ring and the support ring. The plastic of the support ring for this purpose is prepared for example by means of blasting and an adhesive application, which is to ensure the long-term connection. In the case of the sealing ring, elaborately modified versions have to be also used here in order to be able to ensure here adhesion on the support ring in the long term.

Through the pre-treatment of the support material of the support ring and by an application of adhesive or glue and through the possibly required use of special sealing materials, the costs of the sealing devices are substantially increased. In addition to this, material combinations are also known which do not enter into a permanent adhesive connection with one another.

### SUMMARY

The present invention therefore deals with the problem of stating a sealing device with which the disadvantages known from the prior art can be overcome.

According to the invention, this problem is solved through the subject of the independent Claim 1. Advantageous embodiments are subject of the dependent claims.

The present invention is based on the general idea of forming an annular sealing device as two-component sealing device, which means employing a support material for a support ring and a sealing material for a sealing ring and at the same time provide undercut contours of the support ring which when the sealing ring is injection moulded onto the support ring is back-injected and thereby filled out and thereby also allow a long-term reliable mechanical bond between the support ring and the sealing ring. The annular sealing device according to the invention in this case has a support ring of a support material with an axial face end and an inner lateral surface, while the sealing ring is formed of a sealing material and has an L-shaped cross section and in addition lies against the inner lateral surface and against the face end of the support ring where it forms a radial sealing surface and an axial sealing surface. Between its face end and its inner lateral surface, the support ring comprises passage openings which in each case have an undercut that is directed radially to the outside and because of this form a negative form for connecting webs which are produced during the injection moulding of the sealing ring later on. The sealing ring itself is formed from a plastic material, i.e. from the sealing material and injection moulded onto the support ring in such a manner that the axial sealing surface, the radial sealing surface and the connecting webs are formed in one piece and at the same time the undercuts are at least partly filled out with sealing material. Through the firmly bonded connection between the axial and the radial sealing surface via the connecting webs, a permanent mechanical connection between the support ring and the sealing ring can be ensured and at the same time a detaching of the sealing ring from the support ring avoided. By way of this it is thus possible to entirely do without adhesive or glues that were required up to now, as a result of which the operations accompanied by this can be saved and costs reduced. At the same time, material pairings can also be selected which cannot be connected to one another via an adhesive connection.

In an advantageous further development of the solution according to the invention the support ring is formed of metal, in particular of aluminium or of stainless steel. By way of this, a dimensionally stable support ring can be created which ensures a long-term dimensional stability also for the sealing ring. Alternatively to this it is also conceivable that the support ring is formed from a plastic, in particular polyphthalamide (PPA) or from polyamide (PA66). Polyphthalamides are semi-crystalline polyamides and because of their part-crystalline structure have a high melting point. In addition, they also have a high tensile strength and stiffness as well as low friction coefficients and low abrasion coefficients and thus a high resistance to wear. Polyamides are linear polymers with regularly repeating amide bonds along the main chain. Polyamides likewise have a high strength. By way of the mentioned plastics, an extremely dimensionally stable and wear-resistant support ring can be produced. At the same time, such support rings of plastic can be produced in a weight-optimised and cost-optimised manner.

In a further advantageous embodiment of the solution according to the invention, the sealing ring is formed from rubber. Here, elastomers can be employed for example which can develop a long-term sealing effect.

Practically, at least one undercut comprises a T-shaped cross section directed radially to the outside. By way of such a T-shaped cross section, a particularly simple undercut contour can be created which allows a reliable anchoring of the sealing material, i.e. of the sealing ring and because of this reliably prevents the sealing ring becoming radially detached from the inner lateral surface of the support ring towards the inside. Obviously, such undercuts can also have any other contours which make possible anchoring the sealing ring in the sense of tension anchors via the connecting webs on the support ring.

In a further advantageous embodiment of the solution according to the invention, the support ring comprises a total of eight passage openings each with a T-shaped cross section directed radially to the outside in certain regions. By way of such an arrangement of the passage opening that is in particular evenly distributed over the circumference of the support ring a reliable circular fixing of the sealing ring to the support ring can be achieved.

The present invention, furthermore, is based on the general idea of stating a cooling device with a coolant flowing in a cooling circuit and having such a sealing device, wherein the cooling device can comprise for example a coolant cooler, a charge air cooler or an exhaust gas cooler and wherein in this case the sealing device is preferentially arranged at a transition between the coolant cooler, the charge air cooler or the exhaust gas cooler and a coolant line. By way of this, the advantages described in the previous paragraphs regarding the sealing device can also be applied to the cooling device, so that these can be configured reliably tight in the long term by means of the sealing devices according to the invention.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

There it shows, in each case schematically

FIG. 1 shows a support ring according to the invention of an annular sealing device according to the invention,

FIG. 2 shows a sealing ring of the sealing device,

FIG. 3 shows a partly sectioned sealing device for illustrating the undercuts,

FIG. 4 shows a sealing device with a radial step in a cross section which is not part of the invention,

FIG. 5 shows a representation as in FIG. 4, however in an installation situation.

### DETAILED DESCRIPTION

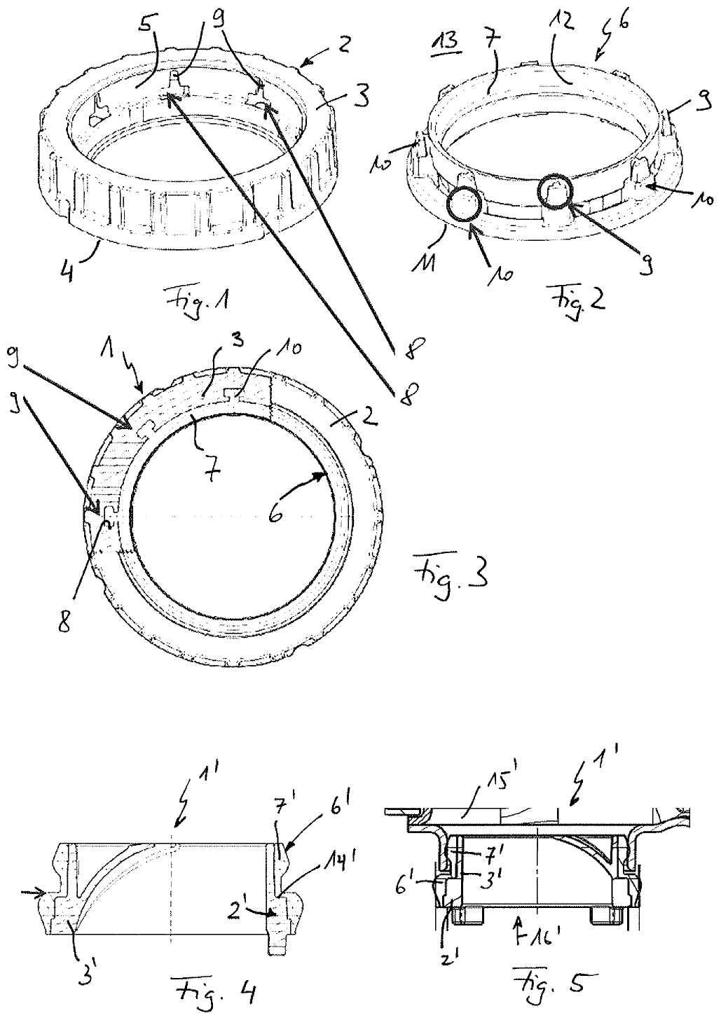

According to FIG. 3, an annular sealing device 1 according to the invention comprises a support ring 2 (see also FIG. 1) of a support material 3 with an axial face end 4 and an inner lateral surface 5. In addition to this, the sealing device 1 comprises a sealing ring 6 (see also FIG. 2) of a sealing material 7, which has an L-shaped cross section and in the installation position lies against the inner lateral surface 5 and against the face end 4 of the support ring 2 and because of this forms a radial sealing surface 12 and an axial sealing surface 11. Here, the support ring 2 comprises passage openings 8 which extend between the face end 4 and the inner lateral surface 5 and represent a passage in between. The passage openings 8 each have an undercut 9 that is radially directed to the outside and form a negative form for connecting webs 10 (see FIGS. 2 and 3). The connecting webs 10 in the finish-produced sealing device 1 extend between the face end 4, i.e. the axial sealing surface 11 and the radial sealing surface 12, i.e. the inner lateral surface 5. Here, the sealing ring 6 is injection moulded onto the support ring 2 in such a manner that the axial sealing surface 11, the radial sealing surface 12 and the connecting webs 10 are formed in one piece and the undercuts 9 are at least partly filled out with sealing material 7. In the FIGS. 2 and 3, the undercuts 9 are also marked, wherein obviously in the case of the sealing ring 6 the undercuts 9 in the present case are shown as positive contours of the connecting webs 10. Accordingly, the undercuts 9 themselves are arranged concealed in the support material 3 of the support ring 2.

The support ring 2 can be formed from a metal, in particular from aluminium or from stainless steel and because of this have a comparatively high shape retention. Alternatively it is obviously also conceivable that the support ring 2 is formed from plastic, in particular from polyphthalamide (PPA) or from polyamide (PA66). Here, both plastics offer the possibility of a cost-effective and high-quality production and moreover have a high resistance to wear and a high strength.

The sealing ring 6 in turn can be formed from rubber, or for example from a plastic, or an elastomer.

Viewing the undercuts 9 in more detail it is evident that these have a T-shaped cross section directed radially to the outside, which is why the individual connection webs 10 later on have the shape of a “T”.

Obviously, the undercuts can also have any other undercut contours which allow a radial anchoring on the support ring 2 radially to the inside in the sense of tensile anchors of the sealing ring 6.

The sealing device 1 according to the invention is employed for example in a cooling device 13 with a coolant flowing in a cooling circuit or a coolant line, wherein the cooling device 13 can comprise for example a coolant cooler, a charge air cooler or an exhaust gas cooler. Here, the sealing device 1 according to the invention is preferentially arranged at a transition between the coolant cooler, the charge air cooler or the exhaust gas cooler and a coolant line.

On the whole, a material pairing between support material 3 and sealing material 7 can be produced with the sealing device 1 according to the invention, which to date has not been possible because of lacking adhesive connection. At the same time, the assembly and thus the production costs can also be lowered with the sealing device 1 according to the invention. Because of the anchoring of the sealing ring 6 via its connecting webs 10 in the undercuts 9 of the passage openings 8 according to the invention, a reliable mechanical connection is also possible which during the production of the sealing device 1 is produced by injection moulding the sealing ring 6 to the support ring 2. However, using the sealing device 1 according to the invention it is not only that an adhesive that has been required up to now can be done without but also a preworking of the support ring 2 or of the sealing ring 6 that is required in such a case.

Viewing the FIGS. 4 and 5, a sealing device 1′ that is not covered by the invention can be seen in the same, which likewise comprises a support ring 2′ of a support material 3′ and a sealing ring 6′ of a sealing material 7′. The sealing device 1′ shown according to the FIGS. 4 and 5 is formed as a plug connection and on the support ring 2′ has a step 14′ which reliably prevents a detaching of a connection, for example a bonded connection between the sealing ring 6′ and the support ring 2′ when sliding the sealing ring 1′ into a component 15′ in the slide-in direction 16′ (see FIG. 5).

1. An annular sealing device comprising:
a support ring of a support material having an axial face end and an inner lateral surface;
a sealing ring of a sealing material which has an L-shaped cross section and lies against the inner lateral surface and the axial face end of the support ring, the sealing ring defining a radial sealing surface and an axial sealing surface;
the support ring having a plurality of passage openings disposed between the axial face end and the inner lateral surface;
the plurality of passage openings each having an undercut of a plurality of undercuts directed radially to an outside, and the plurality of passage openings defining a negative form for a plurality of connecting webs; and
wherein the sealing ring is formed as a plastic injection moulding and is injection moulded onto the support ring such that the axial sealing surface, the radial sealing surface, and the plurality of connecting webs are integrally provided as a single piece and the plurality of undercuts are at least partly filled with the sealing material.

2. The sealing device according to claim 1, wherein the support ring is composed of a metal.

3. The sealing device according to claim 1, wherein the support ring is composed of a plastic.

4. The sealing device according to claim 1, wherein the sealing ring is composed of a rubber.

5. The sealing device according to claim 1, wherein the plurality of passage openings includes eight passage openings.

6. The sealing device according to claim 1, wherein at least one undercut of the plurality of undercuts has a T-shaped cross section directed radially to the outside.

7. A cooling device comprising a cooling circuit through which a coolant is flowable an annular sealing device, the sealing device including:
a support ring of a support material having an axial face end and an inner lateral surface;
a sealing ring of a sealing material which has an L-shaped cross section and lies against the inner lateral surface and the axial face end of the support ring, the sealing ring defining a radial sealing surface and an axial sealing surface;
the support ring having a plurality of passage openings disposed between the axial face end and the inner lateral surface;
the plurality of passage openings each having an undercut of a plurality of undercuts directed radially to an outside, and the plurality of passage openings defining a negative form for a plurality of connecting webs; and
wherein the sealing ring is formed as a plastic injection moulding and is injection moulded onto the support ring such that the axial sealing surface, the radial sealing surface, and the plurality of connecting webs are integrally provided as a single piece and the plurality of undercuts are at least partly filled with the sealing material.

8. The cooling device according to claim 7, further comprising at least one of a coolant cooler, a charge air cooler, and an exhaust gas cooler, wherein the sealing device is arranged at a transition between a coolant line and one of the at least one of the coolant cooler, the charge air cooler, and the exhaust gas cooler.

9. The cooling device according to claim 7, wherein the plurality of passage openings are disposed in the support ring evenly spaced apart from one another in a circumferential direction.

10. The cooling device according to claim 7, wherein each of the plurality of undercuts includes lateral extensions at an outer radially end such that each of the plurality of undercuts has a T-shaped radial cross section relative to an axis of the support ring.

11. The sealing device according to claim 1, wherein the sealing ring is composed of an elastomer.

12. The sealing device according to claim 1, wherein the plurality of passage openings are disposed in the support ring evenly spaced apart from one another in a circumferential direction.

13. The sealing device according to claim 1, wherein each of the plurality of undercuts includes lateral extensions at an outer radially end such that each of the plurality of undercuts has a T-shaped radial cross section relative to an axis of the support ring.

14. The sealing device according to claim 2, wherein the metal is aluminium.

15. The sealing device according to claim 2, wherein the metal is stainless steel.

16. The sealing device according to claim 3, wherein the plastic is polyphthalamide.

17. The sealing device according to claim 3, wherein the plastic is polyamide.

18. An annular sealing device comprising:
a support ring of a support material having an axial face end, an inner lateral surface, and a plurality of passage openings extending between the axial face end and the inner lateral surface, each of the plurality of passage openings having a radially outward extending undercut of a plurality of undercuts; and
a sealing ring of a sealing material having a radial sealing surface, an axial sealing surface, and a L-shaped cross section and including a plurality of webs, the sealing ring arranged on the support ring lying against the axial face end and the inner lateral surface;
wherein the sealing ring is injection moulded and is secured onto the support ring via injection moulding such that the plurality of passage openings are filled with the sealing material defining the plurality of webs therein, the plurality of undercuts are at least partially filled with the sealing material, and the axial sealing surface, the radial sealing surface, and the plurality of connecting webs are integrally provided as a single piece.

19. The sealing device according to claim 18, wherein the plurality of passage openings are disposed in the support ring evenly spaced apart from one another in a circumferential direction.

20. The sealing device according to claim 19, wherein each of the plurality of undercuts includes lateral extensions at an outer radially end such that each of the plurality of undercuts has a T-shaped radial cross section relative to an axis of the support ring.
